(19) United States
(12) Patent Application Publication
(10) Pub. No.: US 2013/0181023 A1
(43) Pub. Date: Jul. 18, 2013

(54) TRUCK BED WINCH MOUNT DEVICE

(71) Applicant: Armando Shawanda, Wikwemikong (CA)

(72) Inventor: Armando Shawanda, Wikwemikong (CA)

(21) Appl. No.: 13/734,311

(22) Filed: Jan. 4, 2013

(30) Foreign Application Priority Data
Jan. 12, 2012 (CA) 2764078

(51) Int. Cl. B60R 9/06

(52) U.S. Cl. CPC B60R 9/06
USPC 224/403

(57) ABSTRACT

A truck bed winch mount assembly provides a mount for a winch in the truck bed of a pickup truck to allow the winch to pull objects into the truck bed. The assembly includes a back rack that has two legs that are joined by upper and lower horizontal cross-members. The back rack attaches to side rails that engage each of the side wall of the truck bed. The winch can be mounted on winch-supporting post that is coupled between a center portion of the upper and lower horizontal cross-members. The side rails have at least two expansion fittings that expand into the stake pockets of the side wall of the truck bed to hold the truck bed winch mount assembly in place. The expansion fittings allow the truck bed winch mount assembly to be easily installed and removed without damaging the integrity of the truck bed. The height of the winch can be adjusted along the winch supporting post.

### FIELD

The present disclosure relates generally to vehicles adapted for transporting loads or objects. More particularly, the disclosure relates to an assembly to facilitate loading objects onto a vehicle.

### BACKGROUND

Many pickup truck owners load heavy objects into the truck bed of their pickup, including recreation vehicles, such as ATVs, snow machines and boats; lawn tractors; furniture; appliances; and wild game. It can often be difficult to load these objects into the truck bed, and typically requires more than one person to load the object. Pickup trucks are also often used to tow other trailers, but it can be difficult to align heavy trailers onto the ball hitch of the pickup truck.

A winch can be used with trucks to assist loading, but this often requires alterations to the truck bed. Typically, holes are drilled into the truck bed to permanently mount the winch or a winch attachment plate. The installation process is also difficult, requiring special tools and knowledge of where to mount the winch in a particular truck model. Each winch install must be customized for the particular make and model of the pickup truck. These approaches damage the integrity of the truck bed making the truck bed susceptible to rust and water damage. A permanent winch also interferes with the normal use of the truck bed by occupying potential cargo space.

### SUMMARY

Accordingly, there is a need for a truck bed winch mount assembly that can easily be installed and removed from the truck bed. There is a further need that the winch mount assembly does not damage the truck bed, or require drilling or otherwise damaging the truck bed integrity.

According to a first aspect, a truck bed winch mount assembly is provided for attachment to a truck bed having sidewalls. The truck bed winch mount assembly comprises a pair of sidewall-engaging side rails, each side rail having mating connector at an end portion of each side rail; a back rack having at least two legs joined by upper and lower horizontal cross-members, the back rack adapted to engage the mating connectors of each of the side rails; and a winch-supporting post coupled between a center portion of the upper and lower horizontal cross-members. Preferably, each of the side rails have at least two expansion fittings to engage stake pockets of the sidewalls to allow the assembly to be easily installed and removed without damaging the truck bed integrity. The expansion fittings have a resilient expansion block that deforms under compression between a threaded plate and the side rail to engage the stake pockets. The truck bed winch mount assembly can also comprise a pair of support braces coupled between the back rack and a corresponding one of the side rails to distribute load forces from the back rack to the side rails.

In a related aspect, the truck bed winch mount assembly can further include a winch-mounting plate that has a sleeve that slideably engages winch-supporting post to allow the height of the winch to be easily adjusted or to easily remove the winch from the assembly. The sleeve can be fixed to any one of a number of winch height positions defined by winch-supporting post.

In another aspect, the back rack of the truck bed winch mount assembly can further includes a safety wall. The safety wall can protect the back window of the truck cab and the driver and passengers in the cab against shifting cargo in the truck bed during a front-end collision or hard braking event.

In yet another aspect, truck bed winch mount assembly is designed as a universal mount to accommodate the different widths of truck beds amongst pickup truck manufacturers. The mating connector and the back rack can accommodate for varying width between side rails engaged to the sidewalls of different sized truck beds. The mating connector can be a mating post that has a threaded insert and the back rack has a horizontal slot to accommodate varying widths, the horizontal slot for receiving a bolt to attach side rail to back rack by engaging threaded insert. In a related aspect, each of the side rails can have a plurality of pre-drilled holes to align the expansion fittings with the varying spacing of stake pockets for different truck beds. The side rails can also have protective material to prevent scratching a top surface of side-walls of the truck bed.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a perspective view of an embodiment of a truck bed winch mount assembly with a safety wall attached to a truck bed;

FIG. 2 is a perspective view of an embodiment of a truck bed winch mount assembly;

FIG. 3 is a side view of an embodiment of a truck bed winch mount assembly;

FIG. 4 is a front view an embodiment of a truck bed winch mount assembly illustrating a back rack and winch-supporting post;

FIG. 5 is a side cross-sectional view of an embodiment of a truck bed winch mount assembly illustrating a mating connection between a side rail and back rack of;

FIG. 6 is a side sectional view of an embodiment of a truck bed winch mount assembly illustrating a side rail and an expansion fitting;

FIG. 7 is a top sectional view of an embodiment of a truck bed winch mount assembly illustrating a support brace between a back rack and a side rail; and

FIG. 8 is a side view of a winch-supporting post and winch plate of an embodiment of a truck bed winch mount assembly;

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

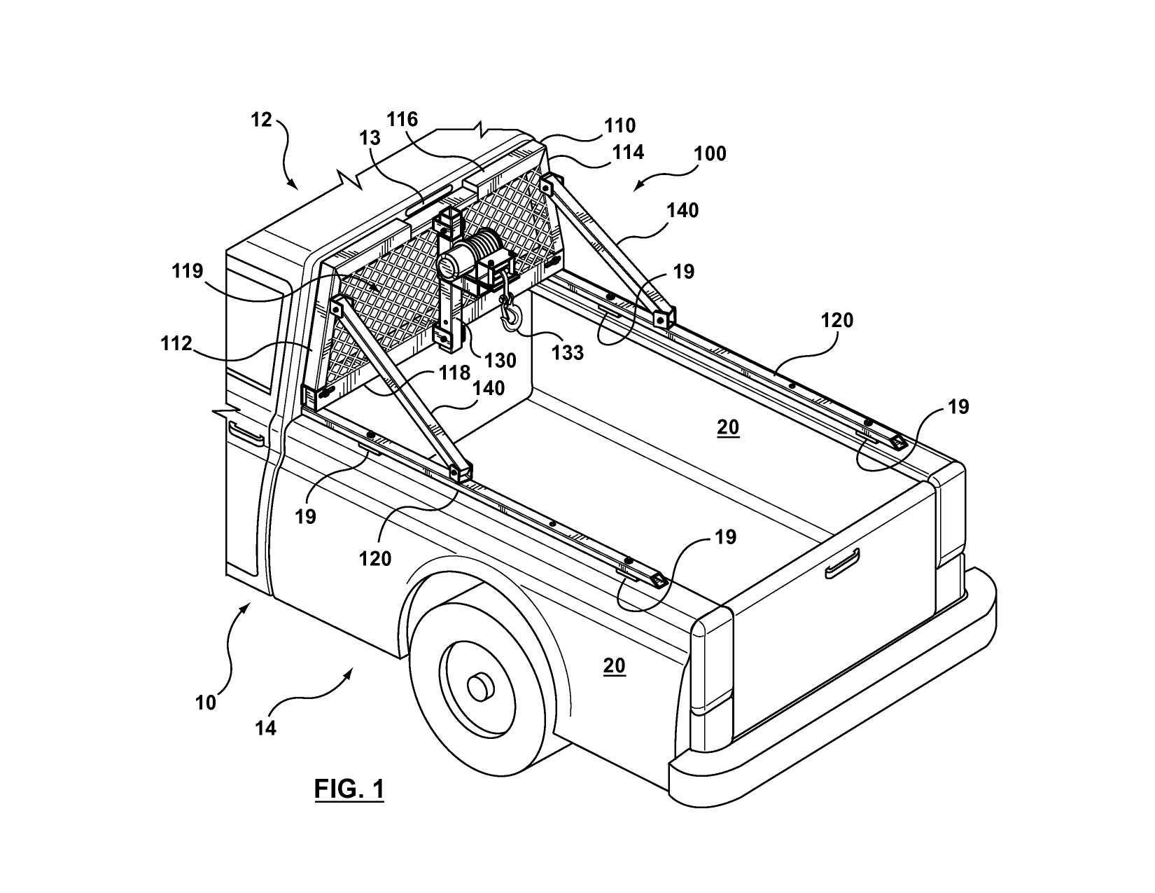

FIG. 1 illustrates a truck bed winch mount assembly 100 that is configured in accordance with a preferred embodiment. Truck bed winch mount assembly 100 is particularly well suited for use with a pickup truck 10. It will be readily understood and appreciated, however, that truck bed winch mount assembly 100 can be used with pickup trucks of different sizes and classes. For instance, truck bed winch mount assembly 100 can be used with full-size, mid-size or compact pickup trucks from a number of different vehicle manufacturers.

As shown in FIG. 1, pickup truck 10 includes a cab 12 at the front of pickup truck 10 and a truck bed 14 extending towards the rear of pickup truck 10. Truck bed 14 has a conventional rectangular shape and includes uprights sidewalls 20 extending from cab 12 towards the rear of pickup truck 10. Each sidewall 20 includes several stake pockets 19 spaced along the length of the sidewall 20. Stake pockets 19 are generally rectangular openings that are defined by the top surface of sidewall 20. The spacing of stake pockets 19 can generally vary between pickup truck manufacturers and the size of pickup truck 10.

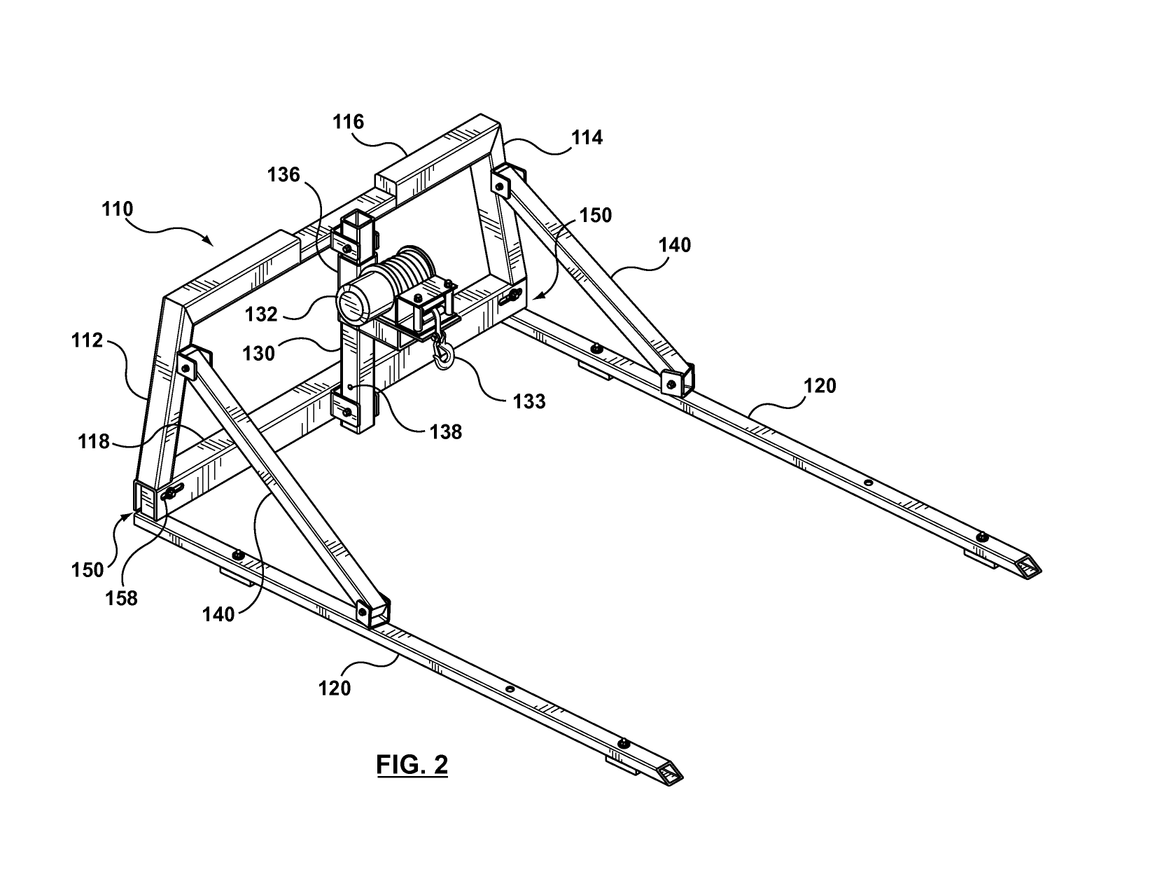

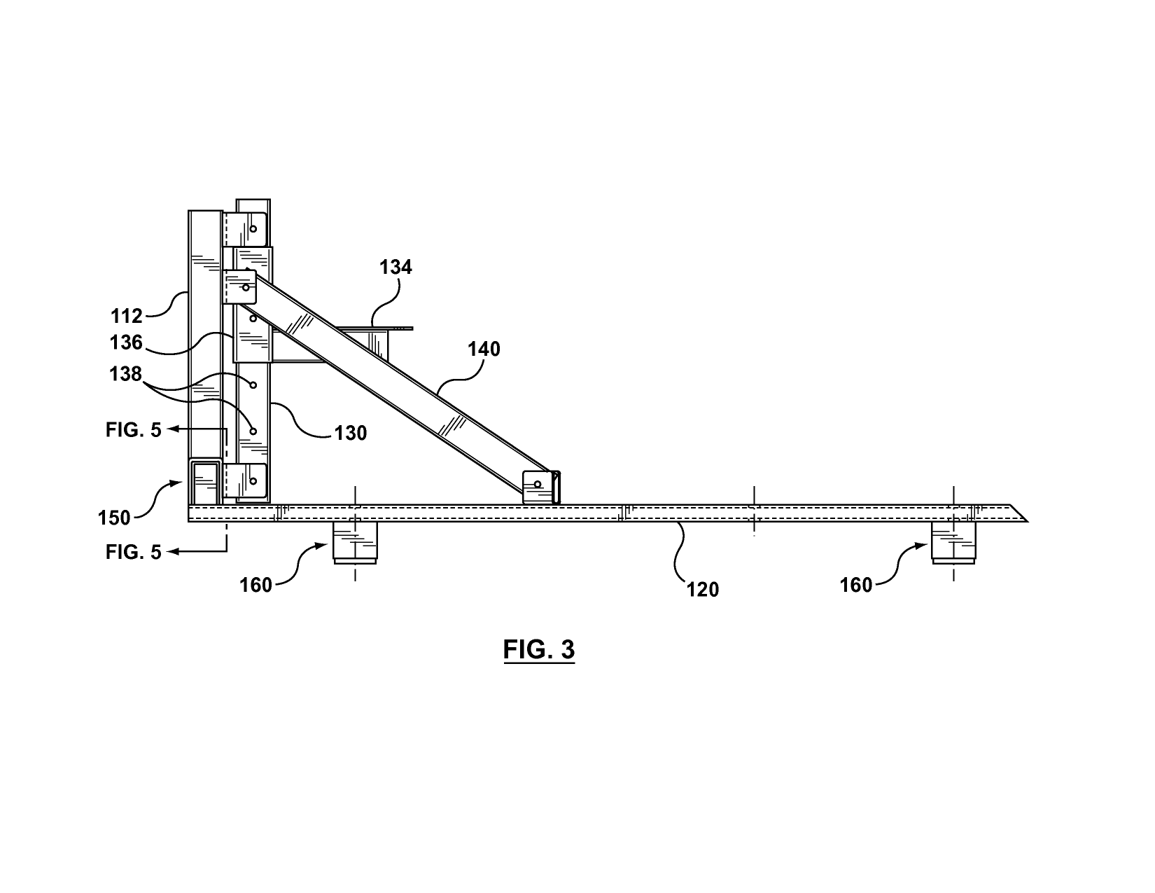

Referring to FIGS. 1, 2 and 3, truck bed winch mount assembly 100 is shown having a back rack 110 that is connected to side rails 120 that are connected to the top surface of sidewalls 20. Back rack 110 is preferably located near the front of the truck bed 14, proximate to cab 12, though other positions in truck bed 14 are also possible. Side rails 120 engage stake pockets 19 to allow truck bed winch mount assembly 100 to be attached to truck bed 14 without damaging or drilling truck bed 14. Truck bed winch mount assembly 100 can easily be installed and removed by a single person.

Back rack 110 includes a pair of upstanding legs 112, 114 that can slant inwards, towards each other slightly. Upstanding legs 112, 114 are joined at their top portion by upper horizontal cross-member 116 and at their bottom portion by lower horizontal cross-member 118. The figures illustrate an embodiment where upstanding legs 112, 114 extend from the top surface of lower cross-member 118.

Back rack 110 can be designed so that upper horizontal cross-member 116 is below the position of brake light 13 of cab 12. Alternatively, horizontal cross-member 116 can be designed to use a thinner segment so as not to obstruct brack light 13. For example, horizontal cross-member 116 can be composed of 2″×2″ square tubing on the edges but use a 1″×2″ square tubing segment in the center portion near brake light 13.

As illustrated in FIG. 1, back rack 110 can also include a safety wall 119 that can be composed of a steal mesh or grid. The steal mesh or grid can be composed of a two inch wire using 3/16″ cold rolled wire that is welded at each intersection. Safety wall 119 can protect the back window of cab 12 and the driver and passengers in cab 12 against shifting cargo in truck bed 14 during a front-end collision or hard braking event. Safety wall 119 can be flush with the surface of back rack 110 that is proximate to cab 12.

Back rack 110 can be sized to fit within truck bed 14 of most full size pickup truck 10 to protect the cab window. Lower cross-member 118 can be between 65.5″ and 75.5″ wide, but is preferably around 70.5″ wide. Upper cross-member 116 can have the same width of lower cross-member but is preferably narrower to align with the profile of cab 12. Upper cross-member 116 can be between 53″ and 73″ wide, but is preferably around 58″ wide. Upstanding legs 112, 114 can extend to provide a height between 18″ and 24″ of back rack 110, but back rack 110 is preferably 20.5″ high with a 2″ lower segment to in the center to avoid obstructing brake light 13. Back rack 110 can be constructed using 2″×2″ square tubing composed of steal, aluminum or other suitable material known in the art.

Side rails 120 connect to back rack 110 by a mating connector 150 on side rails 120. Back rack 110 engages mating connector 150 on each side rail 120 to attach back rack 110 to truck bed 14. Mating connector 150 is preferably an upward protrusion from side rail 120 that can distribute horizontal forces from back rack 110 along side rails 120. Mating connector 150 can extend from side rails 120 into upstanding legs 112, 114 or lower cross-member 118. Preferably, mating connector 150 accommodates for varying width between side walls 20 (and the distances between side rails 120) in different truck beds.

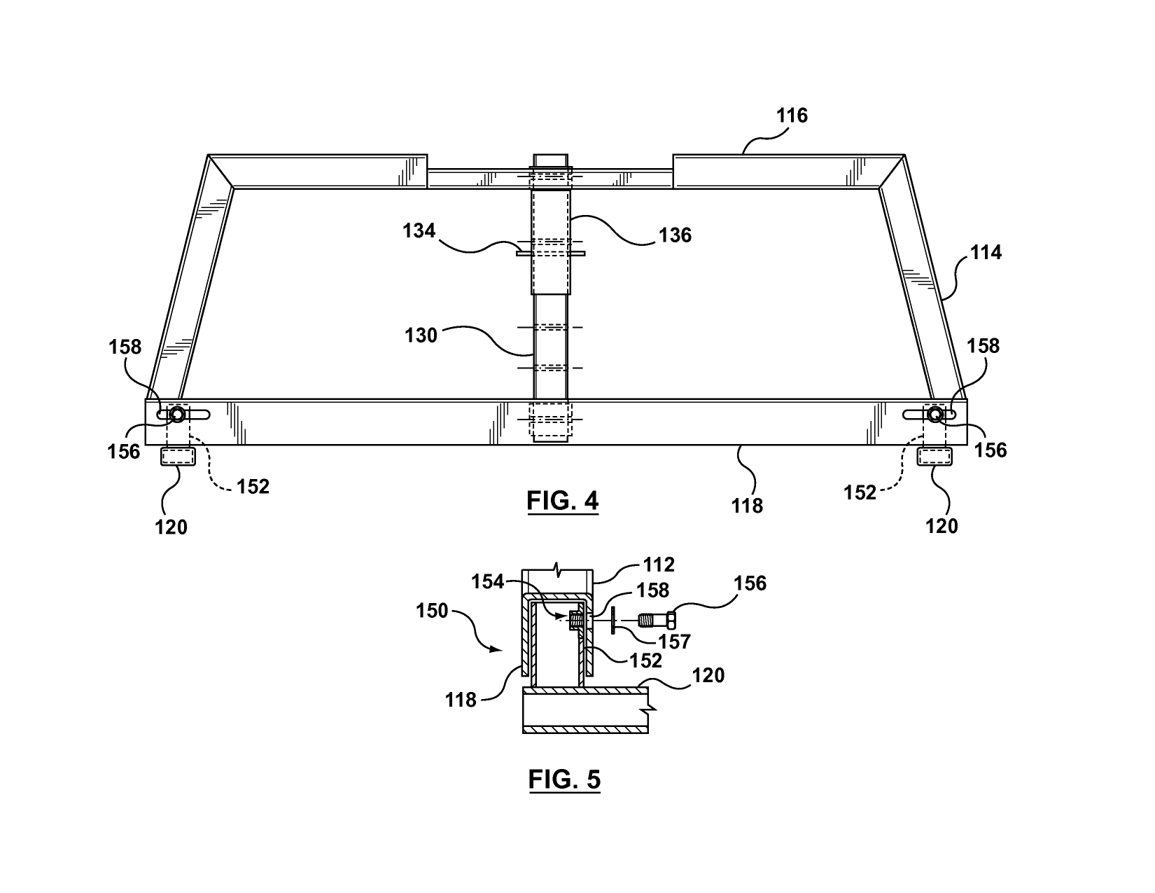

An embodiment of mating connector 150 is illustrated in FIGS. 4 and 5 showing mating post 152 extending upwards from side rail 120 having a threaded connector 154 for receiving a bolt 156. Lower cross-member 118 of back rack 110 has a formed channel that engages mating post 152 on each side rail 120 to attach back rack 110 to side rails 120. Lower cross-member 118 has a horizontal slot 158 that allows back rack 110 to be fit on truck beds having varying widths. Bolt 156 is fed through horizontal slot 158 and threaded into threaded connector 154 so that the head of bolt 156 and washer 157 holds lower cross-member 118 to mating post 152 of side rail 120.

Side rails 120 are mounted to side wall 20 of truck bed 14 via stake pockets 19. In order to accommodate various sized truck beds having different stake pocket spacing, side rails 120 can have pre-drilled holes to align with different stake pocket spacings. Unused pre-drilled holes can be filled with rubber grommets to protect side rails from rain and moisture entering side rails 120. Side rails 120 can also be capped at both ends to prevent damage from moisture. An expansion fitting 160 using resilient material that expands within stake pocket 19 is used to mount side rails to the top surface of side walls 20. Side rails 120 can also have a protective material, such as a foam or rubber cushion, for example, attached to the bottom surface to avoid scratching or otherwise damaging the top surface of side walls 20.

Side rails 120 can be composed of 1″×2″ tubing with a length between 55″ and 75″ to accommodate various truck bed 14 lengths, but side rail 120 is preferably about 67″ long. Mating post 152 can be implemented by welding onto side rails 120 a 2.5″×2″ square tube segment with a ⅜″ threaded insert for accepting bolt 156. The 2.5″×2″ square tube segment can fit within a 2.75″×1.5″ formed channel in the lower surface of lower cross-member 118. Like back rack 110, side rails 120 can similarly be composed of steal, aluminum or other suitable material known in the art. Truck bed winch mount assembly 100 can also be painted with a protective coating or paint and an tubing can be capped to prevent oxidization.

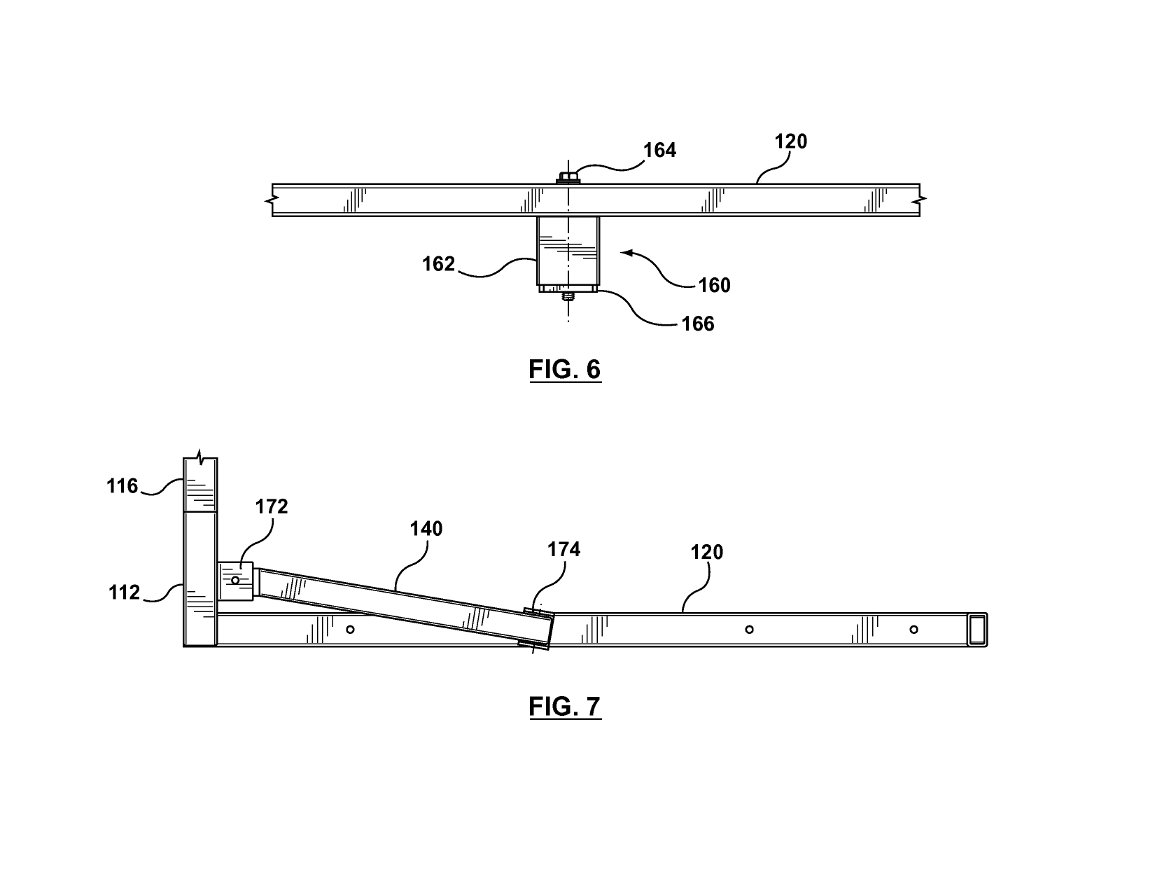

Referring to FIG. 6, a side view of an embodiment of expansion fitting 160 is shown. Preferably, each side rail 120 includes at least two expansion fittings 160 to distribute the towing force from winch 132 to multiple stake pockets 19. Expansion fitting 160 includes an expansion block 162 that has a length-wise hole to accept a compression bolt 164 that has a threaded shank that engages a threaded plate 166 at the bottom of expansion block 162. Expansion fitting 160 is inserted into stake pocket 19 and compression bolt 164 is tightened causing threaded plate 166 to move towards side rail 120. Expansion block 162 is composed of resilient material (e.g. rubber, high density polyethylene) and deforms under the compression to expand and fill stake pocket 19 to attach side rail 120 to side wall 20.

A winch-supporting post 130 is coupled between a center portion of upper and lower cross-members 116, 118. Winch 132 is attached to winch-supporting post 130 and can have a fixed or adjustable position along winch-supporting post 130. Alternative embodiments can utilize a longer winch-supporting post 130 to allow mounting winch 132 to a position above upper cross-member 116 and cab 12. Preferably, winch 132 is mounted to winch plate 134 that attaches to winch-supporting post 132 to allow the winch to be adjusted in height and/or easily removed from truck bed winch mount assembly 100 when not in use. Winch plate 134 can be pre-drilled with holes for mounting most common winches.

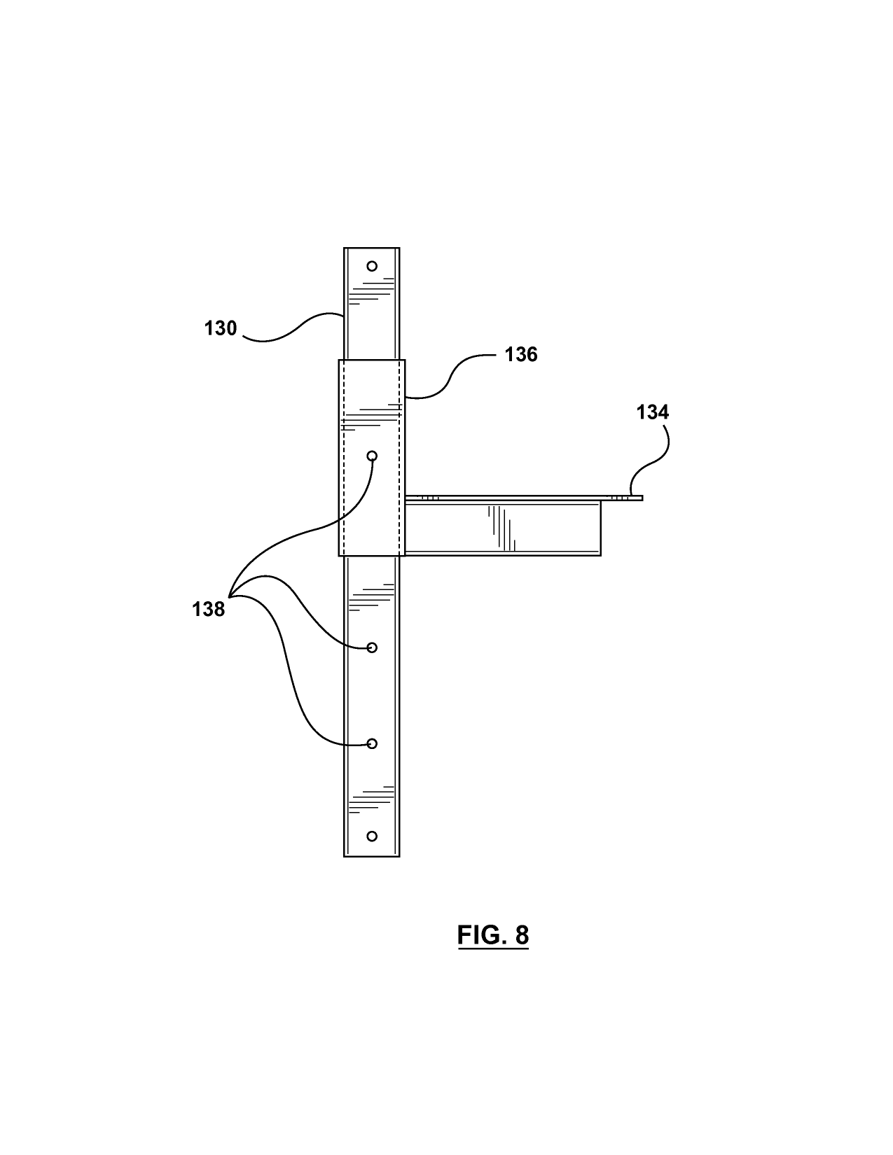

Preferably, as illustrated in FIG. 8, winch plate 134 has a sleeve 136 that allows winch plate 134 to slide along winch-supporting post 130. Sleeve 136 can have a hole that allows a pin to pass through to engage with any one of a number of winch position holes 138 along winch-supporting post 130. Winch 132 and winch plate 134 can easily by removed from truck bed winch mount assembly 100 by removing the pin that affixes winch-supporting post 130 to upper cross-member 116 and pivoting winch-supporting down and back towards the rear of truck bed 14 about the lower pin connection to lower cross-member 118. Winch plate 134 can then slide upwards and off of winch-supporting post 130.

Back rack 110 is also preferably coupled to side rails 120 by support braces 140 that help distribute loads on back rack 110 to side rails 120. Use of support braces 140 can be used to increase the amount of load that can be towed by winch 132. Support braces 140 can be a diagonal connecting member that is coupled to either upstanding legs 112, 114 or upper cross-member 116. Back rack 110 and side rails 120 can have a formed channel for accepting support braces 140, and the formed channel can be attached to support braces 140 using bolts or a clevis pin that is held in place by a cotter or split pin. A top view of truck bed winch mount assembly 100 is shown in FIG. 7 illustrating portions of support brace 140 that attach to the formed channels of back rack 110 and side rails 120.

In order to accommodate for varying width between side walls 20 (and the distances between side rails 120) in different truck beds, support brace 140 can be configured to pivot about side rail 120 and back rack 110. Support brace 140 can have a tongue with a hole drilled through it for accepting a vertically installed fastener 172, such as a bolt or pin. Formed C-channel 174 located on side rail 120 will also be configured to pivot about side rail 120 to accommodate varying angles of support brace 140. Formed C-channel 174 can be affixed to side rail 120 by a bolt inserted into a threaded insert in side rail 120 to provide the desired angle.

Truck bed winch mount assembly 100 can be installed onto truck bed 14 by first placing expansion fittings 160 of side rails 120 into stake pockets 19 and placing side rails 120 on the top surface of sidewalls 20 to align the pre-drilled holes in side rails 120 with spacing of stake pockets 19 of the particular truck bed 14. Next, back rack 110 is placed upon mating post 152 of each side rail 120 and support braces 140 are attached to the formed channels in back rack 110 and side rail 120. After back rack 110 and side rails 120 are positioned, side rails 120 can then be affixed to truck bed 14 by ratcheting down compression bolts 164 and back rack 110 can be attached to side rails by bolt 156 of mating connector 150. Next, winch-supporting post 130 can be attached to back rack 110. Winch-supporting post 130 can be mounted by the bottom-most attachment point first, and then sleeve 136 of winch plate 134 can be slid onto winch-supporting post 130 before attaching the top-most attachment point of winch-supporting post. Winch 132 can then be connected to power, either via a wiring harness, the battery or utility outlet of pickup truck 10.

As apparent from the above description of the installation of side rails 120 and back rack 110, truck bed winch mount assembly 100 is easily installed into and removed from the truck bed 14 without the need of special tools. Also, there is no need to drill holes into truck bed 14 or otherwise affect the integrity of truck bed 14. A single person can install and remove truck bed winch mount assembly 100.

Truck bed winch mount assembly 100 can be used with a ramp (including a simple plywood board) to load heavy items into truck bed 14. Winch hook 133 will be pulled from winch and attached to the object or a harness attached to the object which is aligned with the ramp and truck bed 14. Winch 132 is then operated to pull the object up the ramp and into truck bed 14. Truck bed winch mount assembly 100 can also be used to pull the hitch of a heavy trailer into alignment with the ball attached to pickup truck 10.

The towing force from winch 132 is distributed from back rack 110 to side rails 120 through support braces 140 and mating connector 150. Distributing the towing force allow winch 132 to tow much greater loads than some traditional truck bed winch mounts.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A truck bed winch mount assembly for attachment to a truck bed having sidewalls, the assembly comprising:
a pair of sidewall-engaging side rails, each side rail having mating connector at an end portion of each side rail;
a back rack having at least two legs joined by upper and lower horizontal cross-members, the back rack adapted to engage the mating connectors of each of the side rails; and
a winch-supporting post coupled between a center portion of the upper and lower horizontal cross-members.

2. The truck bed winch mount assembly of claim 1 wherein each of the side rails have at least two expansion fittings to engage stake pockets of the sidewalls.

3. The truck bed winch mount assembly of claim 2 wherein the at least two expansion fittings have a resilient expansion block that deforms under compression between a threaded plate and the side rail to engage the stake pockets.

4. The truck bed winch mount assembly of claim 2 further comprising a pair of support braces coupled between the back rack and a corresponding one of the side rails to distribute load forces from the back rack to the side rails.

5. The truck bed winch mount assembly of claim 4 further comprising a winch-mounting plate having a sleeve that slideably engages winch-supporting post.

6. The truck bed winch mount assembly of claim 5 wherein the sleeve can be fixed to any one of a plurality of winch height positions defined by winch-supporting post.

7. The truck bed winch mount assembly of claim 1 wherein the back rack further includes a safety wall.

8. The truck bed winch mount assembly of claim 1 wherein the mating connector and the back rack can accommodate for varying width between side rails for different sized truck beds.

9. The truck bed winch mount assembly of claim 1 wherein the mating connector is a mating post having a threaded insert and the back rack has a horizontal slot to accommodate varying widths, the horizontal slot for receiving a bolt to attach side rail to back rack by engaging threaded insert.

10. The truck bed winch mount assembly of claim 2 wherein each of the side rails have a plurality of pre-drilled holes to align the expansion fittings with the varying spacing of stake pockets for different truck beds.

11. The truck bed winch mount assembly of claim 1 wherein each of the side rails have protective material to prevent scratching a top surface of side-walls.
